(19) United States
(12) Patent Application Publication
(10) Pub. No.: US 2023/0322128 A1
(43) Pub. Date: Oct. 12, 2023

(54) SEAT LONGITUDINAL ADJUSTMENT MECHANISM, SEAT ARRANGMENT AND SEAT

(71) Applicant: Adient US LLC, Plymouth, MI (US)

(72) Inventor: Erik SPRENGER, Wermelskirchen (DE)

(73) Assignee: Adient US LLC, Plymouth, MI (US)

(21) Appl. No.: 18/188,569

(22) Filed: Mar. 23, 2023

(30) Foreign Application Priority Data
Apr. 6, 2022 (DE) 10 2022 203 402.3
Aug. 2, 2022 (DE) 10 2022 207 953.1

(51) Int. Cl. B60N 2/02; B60N 2/06

(52) U.S. Cl. CPC B60N 2/0232; B60N 2/065; B60N 2002/024

(57) ABSTRACT

A seat longitudinal adjustment mechanism may have two pairs of seat rails which are each formed from a lower seat rail and an upper seat rail, which is movable in a longitudinal direction relative to the lower seat rail. An electric motor may be provided for driving the seat longitudinal adjustment mechanism. The electric motor may be arranged between the two pairs of seat rails. The electric motor may have a single output which may be coupled to one of the two movable upper seat rails. Further, a seat arrangement having a plurality of seats where a seat may have a seat longitudinal adjustment mechanism is provided.

### FIELD

The invention relates to a seat longitudinal adjustment mechanism for a seat, in particular a vehicle seat, to a seat arrangement and to a seat for a vehicle.

### BACKGROUND

Vehicle seats with an electrical seat longitudinal adjustment mechanism having two pairs of seat rails, with an electrical spindle drive being provided per pair of seat rails, are known from the prior art. In the case of a seat arrangement having seat parts which differ in width, loads of differing size may occur, for example because of belt fastening points.

It is an object of the present invention to specify a seat longitudinal adjustment mechanism which is improved, in particular in respect of load absorption, and a vehicle seat having such an improved seat longitudinal adjustment mechanism, and a seat arrangement having such an improved seat longitudinal adjustment mechanism.

The object is achieved according to the invention by a seat longitudinal adjustment mechanism according to the features of the claims.

### SUMMARY

A seat longitudinal adjustment mechanism according to the invention comprises at least two pairs of seat rails which are each formed from a lower seat rail and an upper seat rail which is movable in a longitudinal direction relative to the lower seat rail, wherein an electric motor is provided which is arranged between the two pairs of seat rails and has a single output which is coupled to one of the two movable upper seat rails.

The invention is based on the concept of large differences in the loading of the seat rails occurring in the case of seat arrangements having adjustable seats which differ in width and have seat longitudinal adjustment mechanisms. By configuring a seat longitudinal adjustment mechanism with an electric motor having a single output for one of the movable upper seat rails of two pairs of seat rails, a simple and cost-effective seat longitudinal adjustment mechanism requiring few components is made possible.

Furthermore, the seat longitudinal adjustment mechanism can comprise a reinforcing carrier which is arranged between the two movable upper seat rails and carries the electric motor for driving the seat longitudinal adjustment mechanism. The reinforcing carrier extends, for example, forwards and rearwards in the longitudinal direction of the seat longitudinal adjustment mechanism and in the transverse direction between the two upper seat rails. The reinforcing carrier has, for example, a receptacle, in particular a central receptacle, for the electric motor. The electric motor is arranged and held in the central receptacle. The reinforcing carrier can have an output mounting for movably receiving a flexible output shaft. The output mounting extends in particular between an output end of the electric motor and one of the movable upper seat rails.

Furthermore, the object is achieved by a seat arrangement having at least two seats, in particular vehicle seats, which differ in width in the transverse direction, wherein a seat having a smaller seat width (also called narrow seat) in relation to the other seat or the other seats (also called wide seats) has the previously described seat longitudinal adjustment mechanism.

The seat longitudinal adjustment mechanism of the seat having the smaller seat width comprises two pairs of seat rails running parallel to one another in the longitudinal direction and spaced apart from one another, wherein one of the pairs of seat rails forms an outer pair of seat rails and the other pair of seat rails forms an inner pair of seat rails of the seat longitudinal adjustment mechanism, in particular of the seat arrangement. The seat longitudinal adjustment mechanism has a single electric motor for the seat having the smaller seat width. The single electric motor is arranged between the two pairs of seat rails and has a single output which is coupled to the inner pair of seat rails of the seat having the smaller seat width.

In a development, the reinforcing carrier is manufactured at least in regions from a metal sheet, in particular a reinforcing metal sheet or a composite metal sheet.

Furthermore, the object is achieved by a seat, in particular a vehicle seat, for installing in a vehicle, wherein the seat is at least part of the previously described seat arrangement and/or comprises the previously described seat longitudinal adjustment mechanism. The seat comprises a cushion frame which is connected via a respective mounting to one of the pairs of seat rails.

The mountings here can each form a side frame of the cushion frame.

The reinforcing carrier extends in the seat width direction or transverse direction between the two pairs of seat rails and forwards and rearwards in the longitudinal direction and is connected to the side frames. The reinforcing carrier connects the two side frames and/or the two upper seat rails. The reinforcing carrier forms a bridge. For example, the reinforcing carrier is arranged and held in the vertical direction between the side frames and the upper seat rail.

The advantages obtained with the invention consist in particular in that, in comparison to the prior art, a spindle drive for the narrow seat can be omitted. In the case in particular of rear seat arrangements having a seat width distribution of 60%/40%, loadings of differing size of the seat rails of the respective seat longitudinal adjustment mechanism of adjacent seats occur. For example, two users sit on the 60% seat having two seat surfaces and a belt integration is still provided in the seat for one of the seat surfaces. By contrast, only one person sits on the 40% seat, with a shoulder belt and/or lap belt being fastened to a vehicle body. Accordingly, load requirements in the 60% seat are greater than in the 40% seat. By arranging and coupling the electric motor to the inner pair of seat rails of the seat having the smaller seat width (for example 40% seat), loads which occur at the seat arrangement having at least two or three seats can be better dissipated. In addition, the reinforcing carrier makes it possible to improve, in particular increase, the torsional rigidity of the seat structure, in particular of the cushion frame, of the narrow seat. The reinforcing carrier can better brace the two pairs of seat rails of the narrow seat in relation to one another. Furthermore, the reinforcing carrier reduces a forward shifting of a non-locked, outer, in particular door-side, movable rail in the event of a load stress as a result of an accident, in particular in the event of a load stress in the longitudinal direction in the event of a rear-end collision.

### DESCRIPTION OF THE FIGURES

Exemplary embodiments of the invention will be explained in more detail with reference to drawings, in which:

FIG. 1 shows, in a schematic illustration, a seat, in particular a vehicle seat, having a seat longitudinal adjustment mechanism according to the prior art,

FIG. 2 shows, in a schematic perspective illustration, a seat arrangement having two seats differing in width and associated seat longitudinal adjustment mechanisms,

FIG. 3 shows, in a schematic perspective illustration, a seat longitudinal adjustment mechanism of a seat having a smaller width, and

FIG. 4 shows, in a schematic perspective illustration, a seat structure and the seat longitudinal adjustment mechanism for the seat having the smaller width according to FIG. 3.

### DETAILED DESCRIPTION

Mutually corresponding parts are provided with the same reference signs in all of the figures.

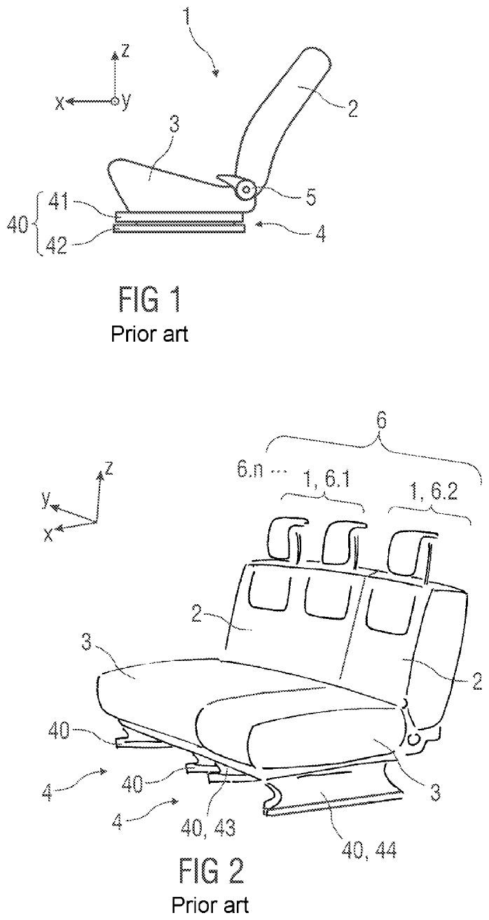

A seat 1 illustrated schematically in FIG. 1 with respect to the prior art, in particular a vehicle seat, will be described below using three directions in space which run perpendicularly to one another. The seat 1 is described below using the example of a vehicle seat and is called vehicle seat 1.

A longitudinal direction x runs, for a vehicle seat 1 installed in the vehicle, largely horizontally and preferably parallel to a longitudinal direction of the vehicle, which corresponds to the customary direction of travel of the vehicle. A transverse direction y, which runs perpendicularly in relation to the longitudinal direction x, is likewise orientated horizontally in the vehicle and runs parallel to a transverse direction of the vehicle. A vertical direction z runs perpendicularly in relation to the longitudinal direction x and perpendicularly in relation to the transverse direction y. For a vehicle seat 1 installed in the vehicle, the vertical direction z preferably runs parallel to a vertical axis of the vehicle.

The information used in relation to position and direction, for example front, rear, top and bottom, relates to a viewing direction of an occupant sitting in the normal sitting position on the vehicle seat 1, wherein the vehicle seat 1 is installed in the vehicle in a use position suitable for transporting a person, and with a backrest 2 upright, and is oriented, as conventionally, in the direction of travel. However, the vehicle seat 1 can also be installed or moved in a different orientation, for example transversely with respect to the direction of travel.

The backrest 2 can be arranged pivotably on a seat part 3 of the vehicle seat 1. For this purpose, the vehicle seat 1 can comprise a fitting 5, in particular a rotary fitting, such as, for example, a latching fitting or tumble fitting.

The vehicle seat 1 can comprise a seat longitudinal adjustment mechanism 4 which can be used to adjust the vehicle seat 1 to and fro in the longitudinal direction x.

The seat longitudinal adjustment mechanism 4 comprises, for example, a pair of seat rails 40 having a first rail 41 and a second rail 42. The first rail 41 is adjustable in the longitudinal direction x relative to the second rail 42. The first rail 41 is fastened to the seat part 3. The second rail 42 is fastened to a structural element of a vehicle, for example a vehicle floor (not illustrated specifically).

The first rail 41 is in particular an upper rail element of the pair of seat rails 40 and is called upper seat rail 41 below for better clarity. The second rail 42 is a lower rail element of the pair of seat rails 40 and is called lower seat rail 42 below for better clarity.

FIG. 2 shows, in a schematic perspective illustration, a seat arrangement 6 having two seats 1 which differ in width and associated seat longitudinal adjustment mechanisms 4.

The seat arrangement 6 is divided into two seats 1 having portions 6.1, 6.2, which differ in width in the transverse direction y, in particular backrest portions and seat part surfaces. In other words: both the backrest 2 and the seat part 3 of the seat arrangement 6 are each divided into the two portions 6.1, 6.2 differing in width. The seats 1 differing in width can be adjusted in the longitudinal direction x with respect to one another independently using the respectively associated seat longitudinal adjustment mechanism 4.

For the sake of clarity, the portions differing in width are numbered from left to right by reference signs 6.1 and 6.2. The portions 6.1 and 6.2 can extend transversely over the vehicle. The portions 6.1 and 6.2 may be, but do not have to be, substantially the same size. For example, the portions 6.1 and 6.2 are designed in FIG. 2 in such a manner that they are divided in the ratio of 60/40 and therefore the portions 6.1 and 6.2 have different widths which extend over approximately 60% and 40%, respectively, of the seat arrangement 6. It is also conceivable for the seat arrangement 6 to be divided into more than two portions 6.n which can have identical or different widths. The seat arrangement 6 can thus be designed, for example, such that it is divided in the ratio 40/20/40.

The wider portion 6.1 of the seat arrangement 6 is called wide seat 6.1 below for the sake of better clarity. The narrower portion 6.2 of the seat arrangement 6 is called narrow seat 6.2 below for the sake of better clarity.

The narrow seat 6.2 having a smaller seat width and the wide seat 6.1 having the greater seat width each comprise a dedicated associated seat longitudinal adjustment mechanism 4 having two pairs of seat rails 40.

The two pairs of seat rails 40 are arranged parallel to one another and spaced apart from one another and run in the longitudinal direction x. With respect to the seat arrangement 6, one of the pairs of seat rails 40 of the narrow seat 6.2 forms an inner pair of seat rails 43 and the other pair of seat rails 40 of the narrow seat 6.2 forms an outer pair of seat rails 44 of the seat longitudinal adjustment mechanism 4.

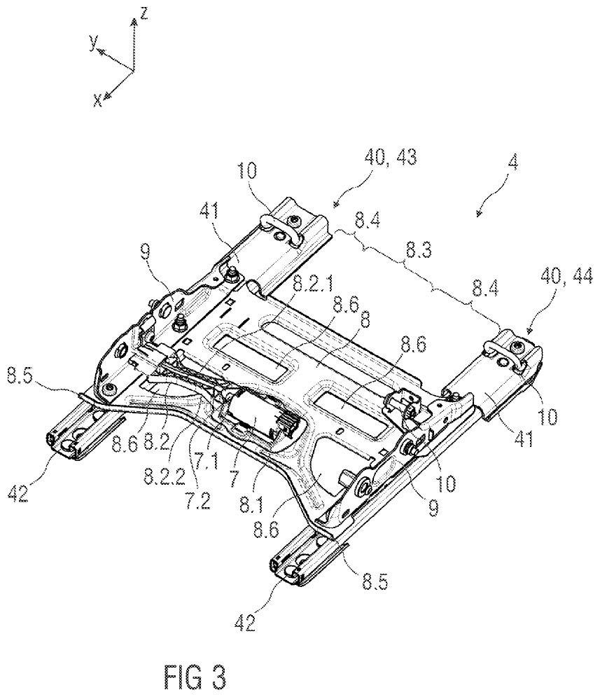

FIG. 3 shows, in a schematic perspective illustration, the seat longitudinal adjustment mechanism 4 having the two pairs of seat rails 40 of the narrow seat 6.2 (illustrated in FIG. 2).

In order to adjust the upper seat rail 41 of the narrow seat 6.2, which upper seat rail is movable in the longitudinal direction x relative to the lower seat rail 42, a single electric motor 7 is provided.

The electric motor 7 is arranged between the two pairs of seat rails 40, in particular between the inner pair of seat rails 43 and the outer pair of seat rails 44.

The electric motor 7 has a single output 7.1. The output 7.1 is coupled to the movable upper seat rail 41 of the inner pair of seat rails 43. In particular, a spindle drive (not illustrated specifically) is arranged within the inner pair of seat rails 43, the spindle drive being driven by the electric motor 7 in order to longitudinally adjust the upper seat rail 41 relative to the lower seat rail 42 of the inner pair of seat rails 43.

The seat longitudinal adjustment mechanism 4 comprises a reinforcing carrier 8. The reinforcing carrier 8 is designed, for example, as a metal sheet, in particular as a reinforcing metal sheet or reinforcing profile or composite metal sheet.

The reinforcing carrier 8 is arranged between the two movable upper seat rails 41. For example, the reinforcing carrier 8 extends forwards and rearwards in the longitudinal direction x of the seat longitudinal adjustment mechanism 4 and in the transverse direction y between the two upper seat rails 41.

The reinforcing carrier 8 can be configured to carry the electric motor 7 for driving the seat longitudinal adjustment mechanism 4. For example, the reinforcing carrier 8 has a receptacle 8.1 which is arranged in particular centrally between the two upper seat rails 41 and in which the electric motor 7 is arranged and held.

In addition, the reinforcing carrier 8 can have an output mounting 8.2 for movably receiving an in particular flexible output shaft (not illustrated). The output mounting 8.2 has a guide channel 8.2.1 centrally for the output shaft. Reinforcing profiles 8.2.2, in particular reinforcing ribs or reinforcing webs, can be provided, in particular integrally formed, to the side of the guide channel 8.2.1.

The output mounting 8.2 extends between the output 7.1, in particular its output end 7.2, of the electric motor 7 and the upper seat rail 41 of the inner pair of seat rails 43.

The reinforcing carrier 8 can comprise a central, constricted region 8.3 in the transverse direction y and a respective widened region 8.4 outwards in the direction of the upper seat rails 41. The respective widened region 8.4 of the reinforcing carrier 8 is adjoined by a fastening region 8.5. In addition, the reinforcing carrier 8 designed as a plate-like metal sheet can comprise a plurality of recesses 8.6 or profilings, in particular indentations and/or bulges.

Two mountings 9 are provided for fastening the seat longitudinal adjustment mechanism 4 to the narrow seat 6.2 (illustrated in FIG. 2).

The reinforcing carrier 8 is connected to the two mountings 9 and/or to the two upper seat rails 41. The reinforcing carrier 8 forms a bridge between the pairs of seat rails 40 and connects the latter. For example, the reinforcing carrier 8 is arranged and held at its ends in the vertical direction z between the mountings 9 and the upper seat rails 41 by the respective fastening region 8.5. For this purpose, the respective fastening region 8.5 is flat.

The respective upper seat rail 41 can furthermore comprise fastening elements 10, in particular for fastening the seat.

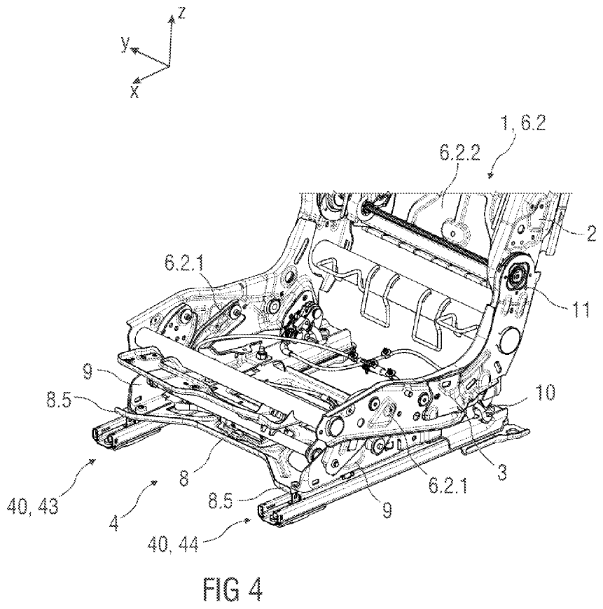

FIG. 4 shows, in a schematic perspective illustration, a seat structure 11 and the seat longitudinal adjustment mechanism 4 for the narrow seat 6.2.

The narrow seat 6.2 in the form of a vehicle seat 1 is provided for installing in a vehicle (not illustrated specifically). The narrow seat 6.2 can be part of the previously described seat arrangement 6 (illustrated in FIG. 2). The narrow seat 6.2 comprises the previously described seat longitudinal adjustment mechanism 4 having only a single electric motor 7 and only a single output 7.1 (illustrated in FIG. 3).

The narrow seat 6.2 comprises a cushion frame 6.2.1 and a backrest frame 6.2.2. The backrest frame 6.2.2 can be configured as a tubular frame or as a backrest shell or backrest metal sheet or as a combination of both (as illustrated).

The cushion frame 6.2.1 is configured, for example, as a tubular frame or as a side frame having two side frame parts (as illustrated). The cushion frame 6.2.1 is connected via a respective mounting 9 to the pairs of seat rails 40, in particular to the inner pair of seat rails 43 and the outer pair of seat rails 44. The mountings 9 here can each form a side frame part of the cushion frame 6.2.1.

By the arrangement and coupling of the single electric motor 7 (illustrated in FIG. 3) to the inner pair of seat rails 43 via the reinforcing carrier 8, loads which occur at the seat arrangement 6 (illustrated in FIG. 2) having at least two seats 1 can be better dissipated. The reinforcing carrier 8 is used to increase the torsional rigidity of the seat structure 11, in particular the cushion frame 6.2.1, of the narrow seat 6.2. In particular, the reinforcing carrier 8 braces the two pairs of seat rails 40 of the narrow seat 6.2 with respect to one another.

### LIST OF REFERENCE SIGNS

1 Seat (vehicle seat)
2 Backrest
3 Seat part
4 Seat longitudinal adjustment mechanism
5 Fitting
6 Seat arrangement
6.1 Portion (wide seat)
6.2 Portion (narrow seat)
6.2.1 Cushion frame
6.2.2 Backrest frame
6.n Portion
7 Electric motor
7.1 Output
7.2 Output end
8 Reinforcing carrier
8.1 Receptacle
8.2 Output mounting
8.2.1 Guide channel
8.2.2 Reinforcing profile
8.3 Constricted region
8.4 Widened region
8.5 Fastening region
8.6 Recess
9 Mounting
10 Fastening element
11 Seat structure
40 Pair of seat rails
41 First rail (upper seat rail)
42 Second rail (lower seat rail)
43 Inner pair of seat rails
44 Outer pair of seat rails
x Longitudinal direction
y Transverse direction
z Vertical direction

1-10. (canceled)

11. A seat longitudinal adjustment mechanism, comprising:
two pairs of seat rails which are each formed from a lower seat rail and an upper seat rail which is movable in a longitudinal direction relative to the lower seat rail, and
an electric motor drives the seat longitudinal adjustment mechanism, wherein the electric motor is arranged between the two pairs of seat rails, wherein the electric motor has a single output which is coupled to one of the two movable upper seat rails.

12. The seat longitudinal adjustment mechanism according to claim 11, wherein a reinforcing carrier is arranged between the two movable upper seat rails and carries the electric motor.

13. The seat longitudinal adjustment mechanism according to claim 12, wherein the reinforcing carrier extends forwards and rearwards in the longitudinal direction of the seat longitudinal adjustment mechanism and in a transverse direction between the two upper seat rails and has a central receptacle.

14. The seat longitudinal adjustment mechanism according to claim 13, wherein the electric motor is arranged and held in the central receptacle of the reinforcing carrier.

15. The seat longitudinal adjustment mechanism according to claim 12, wherein the reinforcing carrier has an output mounting for receiving a flexible output shaft.

16. The seat longitudinal adjustment mechanism according to claim 15, wherein the output mounting extends between an output end of the electric motor and one of the movable upper seat rails.

17. A seat arrangement having at least two seats which differ in width in the transverse direction, wherein a first seat, having a smaller seat width in relation to the at least one other seat, comprises the seat longitudinal adjustment mechanism according to claim 11.

18. The seat arrangement according to claim 17, wherein the seat longitudinal adjustment mechanism of the seat having the smaller seat width comprises two pairs of seat rails running parallel to one another in the longitudinal direction and spaced apart from one another, wherein one of the pairs of seat rails forms an outer pair of seat rails and the other pair of seat rails forms an inner pair of seat rails of the seat longitudinal adjustment mechanism, and the seat longitudinal adjustment mechanism has the electric motor with the single output.

19. The seat arrangement according to claim 18, wherein the electric motor is arranged between the two pairs of seat rails, and the single drive is coupled to the inner pair of seat rails of the seat having the smaller seat width.

20. The first seat adapted to be installed in a vehicle having the seat longitudinal adjustment mechanism according to claim 17, wherein the first seat has a smaller seat width compared to the at least one other seat and is at least part of the seat arrangement.
